(19) United States
(12) Patent Application Publication
(10) Pub. No.: US 2026/0031696 A1
(43) Pub. Date: Jan. 29, 2026

(54) LINEAR MODULE, LINEAR MODULE COMPRISING A MAGNET, AND ENCODER DEVICE FOR DETERMINING THE ANGULAR POSITION AND/OR ASCERTAINING THE POSITION OF A CARRIAGE

(71) Applicant: Cyltronic AG, Winterthur (CH)

(72) Inventors: Jeremias WEHRLI, Winterthur (CH); Marco GUGGISBERG, Frauenfeld (CH); Daniel BAUMANN, Witnerthur (CH)

(73) Assignee: Cyltronic AG, Winterthur (CH)

(21) Appl. No.: 18/858,437

(22) PCT Filed: Apr. 21, 2022
(86) PCT No.: PCT/EP2022/060535

§ 371 Date: Oct. 21, 2024

(51) Int. Cl. H02K 41/02; G01B 7/30

(52) U.S. Cl. CPC H02K 41/02; G01B 7/30

(57) ABSTRACT

A linear module (101) comprising a spindle (5) to be rotated about an axis of rotation (D) of the spindle (5), a spindle nut (51) for converting a rotary movement of the spindle (5) into an axial movement of the spindle nut (51), a coupling unit (6) to be moved axially along a guide rail (7), driven by the spindle nut (51), the guide rail (7) for guiding the coupling unit (6), which runs parallel to the spindle (5), a preferably brushless motor (8) having a stator (9) and a rotor (10) for driving the spindle (5), a control device (14) that is configured to control the motor (8) and comprises at least one circuit board (13), a housing (21) that at least partially encloses a housing interior (211) and a carriage (19) that is arranged at least partially outside the housing (21) and is able to be coupled with a movement of the coupling unit (6), such that the carriage (19) is able to be moved parallel to the guide rail (7) by the movement of the coupling unit (6), characterized in that the motor (8), the control device (14), the spindle (5), the spindle nut (51) and the guide rail (7) are arranged in the housing interior (211).

The invention relates to a linear module and a linear module with a magnet for determining the angular position and/or determining the position of a carriage.

Known linear modules, often also referred to as linear axes or linear units, comprise an electrical motor to drive the movement of a carriage by converting a rotational movement of the motor into a linear movement of the carriage.

However, known linear module designs are often complicated to operate, as linear modules are often used in confined spaces, especially inside the machine. In addition, external and/or large control devices must usually be provided to control the linear modules. The external control devices are often installed in the control cabinet of the machine in which the linear module is installed or outside the housing of the linear module.

EP 0 647 503 A2 discloses a linear guide unit and system with a plurality of covers for transmitting a linear driving force.

However, the control of known linear modules in the state of the art is complex and only has complex setting options for the control and/or compatibility with the installation environment or other modules.

The purpose of the present invention is to overcome these and other disadvantages of the prior art. In particular, the invention is intended to provide a linear module and a linear module comprising a magnet and an encoder device which enable simple and cost-effective control of the linear module.

Another task of the invention is to provide a linear module with a compact design. It is also an aim to provide a linear module with reduced complexity, which can be used flexibly and in a variety of ways, regardless of the control system and the installation environment.

This task is solved by a linear module comprising a spindle for rotation about a rotation axis of the spindle and a spindle nut for converting a rotational movement of the spindle into an axial movement of the spindle nut. The linear module also comprises a coupling unit for axial movement along a guide rail, driven via the spindle nut. The linear module also comprises the guide rail for guiding the coupling unit, which runs parallel to the spindle. In addition, the linear module comprises a motor, preferably brushless, with a stator and a rotor for driving the spindle, a control device which is configured to control the motor and has at least one circuit board. The linear module has a housing, which at least partially encloses a housing interior, and a carriage, which is arranged at least partially outside the housing and is coupled to a movement of the coupling unit. The carriage is moveable parallel to the guide rail by the movement of the coupling unit. The motor, the control device, the spindle, the spindle nut and the guide rail are arranged in the housing interior.

In this context, the term “coupled” in relation to the coupling unit and the carriage means that the coupling unit is moveable together with the carriage in that a mechanical and/or magnetic connection exists or can be established between the two. For this purpose, the carriage and the coupling unit may comprise, for example, a magnet and/or magnetizable material or connection elements, or receiving areas for connection elements.

The housing interior can be partially, in particular completely, enclosed by the housing, housing screws protruding from the housing and opening levels of openings in the housing.

Preferably, this movement is driven by a brushless motor of the linear module, as this is subject to significantly less wear and has a longer service life compared to brushed motors.

The linear module may comprise a, preferably flexible, cover and the housing may have an opening which is at least partially covered by the cover. The carriage is arranged at least partially, in particular completely, outside the housing, adjacent to a top side of the cover, and is connected to the coupling unit, which is arranged adjacent to a bottom side of the cover.

The coupling unit can be arranged at least partially inside the opening and protrude from the housing.

The carriage and the coupling unit can be detachably connected to each other mechanically or magnetically by connection elements.

The cover prevents damage and contamination caused by dust or dirt, as well as the resulting wear of the components in the housing interior of the linear module.

The carriage and in particular the coupling unit can slide along the cover parallel to the spindle with little friction loss. The carriage can have at least one upper sliding element adjacent to a top side of the cover. In addition, the coupling unit can have at least one lower sliding element adjacent to a bottom side of the cover.

In an embodiment with a magnetically coupled carriage and coupling unit, however, the sliding elements of the carriage and/or the coupling unit can be arranged adjacent to an inner and outer area of the housing instead of on the cover.

The opening of the housing can extend over a large part of the housing in the longitudinal direction of the linear module, so that the carriage is moveable along the opening in the longitudinal direction.

The cover can be formed by a metal sheet, in particular comprising stainless steel. The sheet metal can have a thickness of less than 0.5 mm, in particular 0.3 mm, and in particular 0.2 mm. The metal sheet can be flexibly deformable perpendicular to the metal sheet plane. The sheet metal can be curved outwards, preferably in the area of the carriage. Moving the carriage can shift the position of the curvature so that at least a large part of the opening is always covered.

The carriage can cover lateral openings in the curvature of the cover, further minimizing the ingress of impurities into the housing interior while still allowing force to be transmitted to the carriage.

The sliding elements adjacent to the bottom side and top side of the cover can be arranged at a distance from each other in the longitudinal direction of the linear module. At least two upper sliding elements can frame a lower sliding element in the longitudinal direction of the linear module. The upper sliding elements can be arranged closer to the opening of the linear module than the lower sliding element.

At least one surface of a sliding element can be arranged at an angle, optionally from 1° to 60°, preferably 5° to 30°, to the longitudinal direction of the linear module. The surface of the sliding element can be at least partially convex or concave. The surface of the sliding element can at least partially have a polynomial shape, in particular the shape of a fifth degree polynomial. This surface may maximize the overlying surface of the sliding element for cover and reduce friction. In particular, the lower sliding element may form an at least partially convex surface and the upper sliding element may form an at least partially concave surface.

The carriage and/or the coupling unit can contact the cover mainly, in particular exclusively, with the sliding elements. Thus, a reliable and low friction movement of the carriage along the cover can be achieved.

The motor can be arranged coaxial to the spindle, preferably in an end section of the spindle, so that the rotor and the spindle have the same rotation axis. In addition, the rotor can be rigidly connected to the spindle, in particular without a separate connection element.

This arrangement of the motor, in particular the rotor, coaxial and in particular in the end section of the spindle means further space and cost savings.

The advantage of preferably fixing the rotor to the spindle is that there is no need for a mechanical gearbox and no separate coupling for power transmission.

As a result, the bearing of the spindle is also the bearing of the motor, so fewer components are required and costs are minimized.

The coupling unit can comprise a ball or roller recirculation system, which has a plurality of rollers or balls that allow the coupling unit to run with low friction relative to the guide rail.

The ball or roller recirculation system can be arranged in a carriage of the linear module. Several ball or roller recirculations can also be arranged in one carriage. The carriage can thus be designed to be movable relative to the guide rail. In addition, the carriage can be rigidly connected to the coupling unit.

The ball or roller recirculation system achieves lower friction of the carriage or coupling unit on the guide rail and improves the bearing on the guide rail.

The linear module can include a holding brake. The holding brake can be reversibly transferred from a holding state to a release state. The holding state prevents rotational movement of the spindle and the release state enables rotational movement of the spindle.

The holding brake enables the position of the coupling unit and the carriage relative to the spindle to be reliably maintained in the holding state, even if load peaks occur.

The holding brake can be an electrical, in particular an electromagnetic, holding brake and have a mechanical transmission element.

The electrical holding brake is designed in such a way that the holding state can be achieved in a de-energized state of the holding brake, in particular by mechanically preloading the mechanical transmission element.

The mechanical transmission element can comprise a reset element, in particular a spring.

The holding brake in the de-energized state allows the load to be held even in the event of a power failure. This increases safety and reliability when using the linear module.

In addition, the holding brake only needs to be energized when the spindle is actively moving in order to be transferred to the release state. Depending on the load and the active operating time of the linear module, the power consumption can thus be saved when passively holding the linear module in the holding state.

The holding brake can have a separate power supply or be powered by the connection of the linear module. A separate power supply makes it easy to retrofit a holding brake.

The holding brake can be arranged at one end face of the linear module, preferably in a holding brake cover of the linear module. The holding brake can therefore be easily attached/replaced.

The holding brake can be arranged at one end of the spindle and the end of the spindle can have at least one radial projection and/or a radial recess. The projection and/or the recess is at least partially form-fittingly coupled to a hub of the holding brake in the holding state, preferably also in the release state.

The hub of the holding brake and the end of the spindle can be at least partially, preferably completely, complementary to each other.

Partially form-fitting coupled in this context means that the end of the spindle engages with the hub of the holding brake by means of a positive fit and/or a frictional connection. This means that the spindle can only be rotated in the circumferential direction together with the holding brake or a component, in particular the hub, of the holding brake.

The hub of the holding brake can be rotatably mounted in the holding brake.

Such a coupling enables the position of the spindle to be held precisely at a position without current by transferring the holding brake from the release state to the holding state by pretensioning the mechanical transmission element. This minimizes power consumption and an angular position of the spindle can be held precisely.

The control device of the linear module may be configured to control at least two of the following parameters: a power supply of the motor, in particular for commutation of the motor, a position value defined by the relative distance of the carriage to an end of the spindle, a speed of movement of the coupling unit, an acceleration of movement of the coupling unit, a force of movement of the coupling unit, and a direction of movement of the coupling unit.

The separate setting of the parameters by the control device allows the linear module to be used flexibly for a wide range of possible applications. In addition, no external control of the parameters by an external control device is required. However, optional or additional control by an external control unit is also possible.

The speed, acceleration and/or force can be controlled separately depending on the axial direction of movement. The value for at least one of these parameters can be set differently in one direction of movement by the control device than in another direction of movement, in particular in the opposite direction of movement.

The control device can also be configured to determine the position value, in particular by determining the revolutions and/or the angular position of the spindle.

The circuit board can be a rigidly mounted circuit board and the control device can have exactly one rigidly mounted circuit board.

In this context, the term “rigidly printed circuit board” refers to a circuit board that is not plastically deformable and, in particular, has a flat planar surface on which the electronic components can be mounted.

The use of exactly one rigidly mounted circuit board for the control device saves space. Alternatively, the linear module can comprise two, in particular rigidly mounted, circuit boards.

The mounting of only one rigidly mounted circuit board of the control device under one of the sides of the linear module requires that the control device is optimized with respect to the limited space of the housing interior and that all electronic components can be mounted on the rigidly mounted circuit board, preferably without increasing the dimensions compared to known linear modules.

Furthermore, the arrangement of a single circuit board enables a short connection to the motor, which has a positive effect on the electromagnetic compatibility behavior.

The circuit board may comprise small and large electronic components with respect to the overall height perpendicular to a plane of the circuit board. At least one electronic component, preferably all large electronic components, in particular transistors and/or converters, are arranged at the edge of the circuit board, in particular at the edge of a longer side of the circuit board of the control device.

This reduces the space required by the circuit board in the housing interior. The electronic components can be mounted on the circuit board so that they are as far away as possible from the spindle axis and protrude into the housing interior to the sides of the spindle, as there is space available at this point.

In relation to the circuit board, this means that the larger electronic components are preferably mounted on the edge of the longer sides of the circuit board with the longest extension of the electronic components perpendicular to the circuit board.

The control device may include a connection for power supply and a connection for communication with the control device.

Communication with the control device can enable external control and, in particular, external input of the parameters of the control device.

Two separate connections ensure a high degree of safety in the event of a defect or failure, as the power supply is independent of the control unit.

The linear module, in particular the control device, can comprise an interaction element. The interaction element comprises adjustment elements and/or status indicators. The adjustment elements are used for speed adjustment and/or force adjustment directly on the linear module.

An interaction element directly on the linear module means that no external electronics are required to operate the linear module. Adjustments can be made directly on the linear module, which simplifies control.

This has the advantage that any user can commission the linear module without any software knowledge, making it suitable for a wide range of applications.

To move the carriage to a predefined position, an external control device can transmit an instruction to move to the predefined position to the internal control device of the linear module. The control device can in turn control the motor on the basis of this instruction in order to move the carriage to the predefined position.

Possible elements that can be set with the interaction element are the potentiometers for the speed and the force depending on the direction of movement. One direction of movement can be aligned along the guide rail towards the motor and the other direction of movement can be aligned along the guide rail away from the motor. The control device can also be configured to automatically adjust commutation and control of the motor based on these settings.

Preferably, the interaction element has adjusting screws for the speed when extending and retracting (speed IN/OUT) and/or an adjusting screw for the force.

The interaction element preferably comprises status indicators that display the user's value settings and/or indicate the status of the device, preferably by means of lights, diodes, LEDs and/or a display.

This has the advantage that the user of the linear module can read out the status of the linear module via a visual output without the need for external hardware and/or software.

These status indicators provide information about the linear module, preferably via LEDs.

The interaction element can be attached directly to the housing with fastening elements and preferably serve at least partially as a housing cover.

The linear module can comprise at least one connection element, which is arranged on the carriage. The linear module can comprise at least one further connection element, which is formed at one end or at both ends of the housing, in particular on the end faces of the housing, preferably on the covers.

The connection elements allow flexible use of the linear module and a way to connect the linear module. The connection elements can be used to attach the linear module, in particular the carriage, to an external device part, for example.

A minimum cross-sectional dimension of the linear module orthogonal to the spindle axis is preferably never wider than 150%, in particular 130%, further in particular 120%, of an outer diameter of the motor, apart from the connections protruding from the housing, the interaction elements, the housing screws and the carriage.

The outer diameter of the motor refers to the outer diameter of the outer part of the motor, i.e. either the stator as the outer part or the rotor as the outer part.

This means that at least one dimension of the housing is only slightly wider than the motor. This has the advantage that the housing is very compact, despite the internal mounting of the motor, spindle, spindle nut and control device.

Bearing elements can be arranged coaxial to the spindle, on both sides of the rotor. In particular, the bearing elements can be axial ball bearings, deep groove ball bearings, tapered roller bearings or cylindrical roller bearings or comprise these.

This has the advantage that the rotor is well supported by the relatively wide bearing, the load distribution for the motor is improved and at the same time the spindle is well supported. This ensures a longer service life for the linear module.

The linear module can have an essentially polygonal housing, preferably with an essentially quadrangular cross-sectional area, in particular with an essentially rectangular or trapezoidal cross-sectional area. In addition, one body of the housing can be made of an extruded aluminum profile.

The polygonal shape has the advantage that it allows a circuit board to be accommodated in the housing interior in the most space-saving way possible without enlarging the housing.

The housing of a linear module should ideally be made of a lightweight but stable material. An aluminum extrusion has a low weight, is inexpensive and is therefore well suited for a linear module. The use of an extruded aluminum profile allows the linear module to have a very compact design with the advantage that no external electronics or even cooling need to be used.

Nevertheless, the linear module could easily be provided with additional internal cooling, such as fans or heat exchangers, or external cooling, as the coils of the stator, which are heated during operation, are preferably mounted on the outside of the housing.

The size of the motor can therefore be easily adjusted, which slightly improves the heat dissipation of the motor.

The housing can have the same cross-sectional dimension over its entire length, apart from the connections, the opening, the coupling unit, the carriage, the housing screws and the interaction elements.

The constant cross-sectional dimension makes it easier to manufacture the housing and install the linear module components in the housing interior.

The housing can comprise two housing covers on the end face. Preferably, the housing also comprises at least one housing cover on the body side. One of the end-face housing covers can also be a motor housing of the motor. The other of the end-face housing covers can preferably support the spindle and/or be a holding brake housing of the holding brake.

The control device, in particular the circuit board, can be covered by the housing cover on the body side, on which the interaction elements are arranged. The housing cover can be detachably attached to the housing body for this purpose, such as being screwed on. This has the advantage of ensuring easy access to the electronic components. In addition, the circuit board can be easily replaced or a defect in the interaction elements can be rectified. In addition, there is no need for complicated cabling entries through drill holes and the associated seals in order to insert components into the interior of the housing.

Mounting the motor in the housing cover enables a compact design, as the front housing cover also forms the motor housing, thus saving space.

The housing cover of the motor can be designed in one piece so that the motor is essentially completely inside the housing cover. Fastening elements for fastening the housing cover can be arranged in such a way that a connecting groove of the housing and housing cover is arranged axially next to the motor.

This means that the cover can be adapted to the dimensions of the rotor and/or stator and additional space can be saved in the housing interior, resulting in smaller external dimensions of the linear module.

The housing cover can also contain a bearing element for mounting the spindle.

The housing cover for the spindle bearing can be interchangeable with a cover that also serves as a holding brake housing for the holding brake. This enables flexible adaptation and/or expansion of the linear module to use a holding brake.

The covers can be flush with the housing in that the covers have the cross-sectional dimension of the housing.

Determining the axial position of the carriage and the angular position of the spindle in linear modules is sometimes only possible with large components in the state of the art and therefore requires a lot of space. However, determining the axial position and angular position makes it possible to draw conclusions about the position of the rotor in relation to the stator so that the motor can be commutated and, in particular, a brushless motor can be used.

According to a further aspect of the invention, it is therefore a task of the invention to overcome these disadvantages of the prior art and to develop a linear module which provides a cost-effective and space-saving method for determining the axial position of the carriage and angular position of the spindle.

The task is solved by a linear module according to the independent claims.

A linear module, in particular as described above, comprises a brushless motor with stator and rotor, a spindle, a spindle nut for converting a rotational movement of the spindle into an axial movement of a coupling unit. Furthermore, the linear module comprises the coupling unit for axial movement along the guide rail, driven by the rotation of the spindle. The linear module also comprises a guide rail for guiding the coupling unit, which runs parallel to the spindle, and a carriage, which is coupled to the coupling unit. The carriage is moveable parallel to the spindle by moving the coupling unit. The linear module may further comprise a control device configured to control the motor. The linear module has at least one magnet on or in an end face of the rotor and/or the spindle, as well as an encoder device substantially axial to a rotation axis of the spindle. The encoder device is configured for reading the angular position of the magnet and/or determining the axial position of the carriage.

This attachment of the encoder device and the magnet has the advantage that the position of the magnet can be read out in a very space-saving manner. In this context, it would also be conceivable to attach the magnet to the rotor or a separate component that is connected to the spindle, especially if the rotor or the separate component is not firmly connected to the spindle.

With the help of a counter and the information about the thread of the spindle, as well as the angular position of the magnet, the axial position of the carriage can now be determined by the encoder device and optionally the control device. This offers the advantage that the position of the carriage can be determined without the readout device consisting of magnet and encoder device having to perform an axial movement along the rotation axis of the spindle.

The encoder device can comprise at least one, preferably rigidly mounted, circuit board, which is arranged axially to the rotation axis of the spindle.

In an alternative embodiment, the encoder device, in particular a circuit board, can be arranged at least partially in a circumferential direction relative to the spindle and not or not exclusively axially behind the rotation axis. In addition, the encoder device and the control device can be rigidly connected to each other, in particular arranged on a circuit board.

In another embodiment, the magnet can also be mounted away from the rotation axis, laterally on the face of the spindle, while the encoder device is mounted axially in the center of the spindle. The information on the angular position is therefore derived from the change in the direction of the magnetic field caused by the rotation of the spindle.

Preferably, however, the magnet is arranged on the rotation axis of the spindle, as this offers the advantage that no imbalance can occur.

The magnet can have the north pole on one side radially away from the rotation axis and, in particular, have the south pole radially on the opposite side of the rotation axis. The magnet can be a disc magnet that is rotationally symmetric about the rotation axis.

Preferably, the magnet has an orthogonal polarity to the axis of the spindle. This polarity offers the advantage that it can be placed centrally on the spindle without shifting the center of gravity and can be easily read. A diametral magnet is well suited for this application, but other magnet shapes are also possible.

The magnet with encoder device for determining the angular position and axial position offers the advantage of a large space saving, as the axial position of the carriage is measured only by rotating the magnet, statically at the same point.

The magnet with encoder device can be used to determine the rotational speed of the rotor, spindle and/or commutation of the brushless motor based on the signal from the electronic encoder device and/or control device.

This has the advantage that the use of a brushless motor is possible through appropriate commutation and no additional mechanical gearbox is required.

The task is further solved by using a magnet on or in an end face of a spindle or the rotor of a linear module, preferably as described above. An angular position of the magnet can be read out with an encoder device for determining the rotational speed of a spindle and/or commutation of a motor by means of the signal of the electronic encoder device and, in particular, a control device. The encoder device, in particular the control device, can control the rotational movement of the spindle and/or the commutation of the motor on the basis of the read-out orientation of the magnet.

This enables the use of a brushless motor through appropriate commutation, without additional sensors such as Hall sensors.

For commutation, the position/angular position of the rotor to the stator must be known at all times.

As the rotor is preferably rigidly connected to the spindle and the magnet is rigidly connected to the spindle, the angular position of the magnet also determines the position of the rotor. This has the advantage that the relative position of the rotor to the immovable stator can be measured at any time.

This means that a brushless motor can be used. A brushless motor, preferably a BLDC motor, is more efficient than brushed motors or stepper motors, which have a high holding torque and are less dynamic, and has a longer service life due to the lower wear. Commutation of the motor, i.e. energizing the right coils at the right time, must be carried out via the electronic components of the control device and/or the encoder device and the specific angular position.

The invention is explained in more detail with reference to figures, which are merely examples of embodiments. They show:

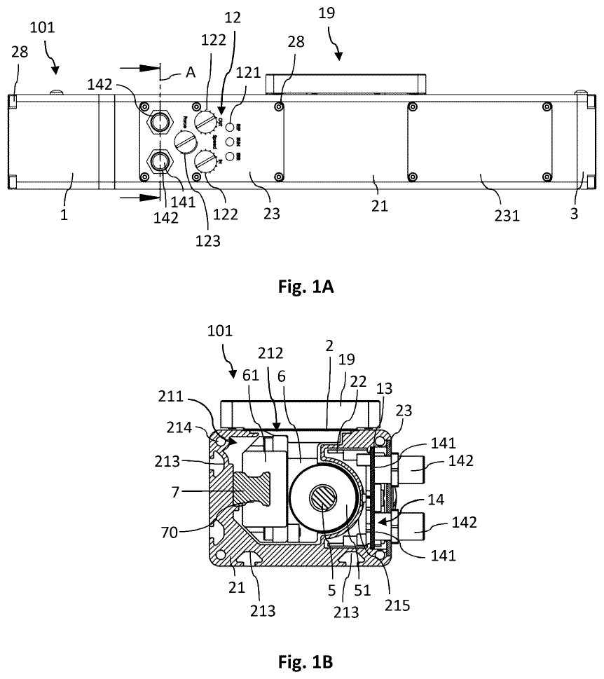

FIG. 1A: a side view of a version of the linear module according to the invention,

FIG. 1B: a cross-section of the linear module version shown in FIG. 1A,

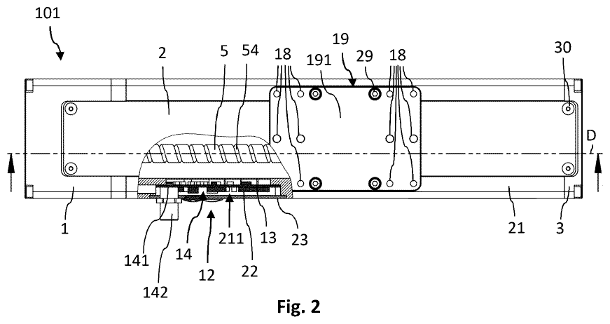

FIG. 2: a top view of the linear module design according to FIG. 1A and FIG. 1B with a partial cross-section,

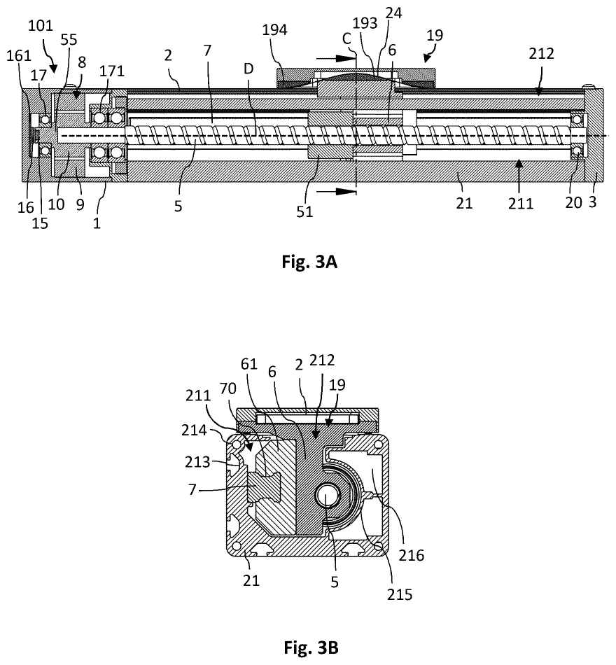

FIG. 3A: a longitudinal section of the linear module version according to FIG. 2,

FIG. 3B: a cross-section of the linear module version shown in FIG. 3A,

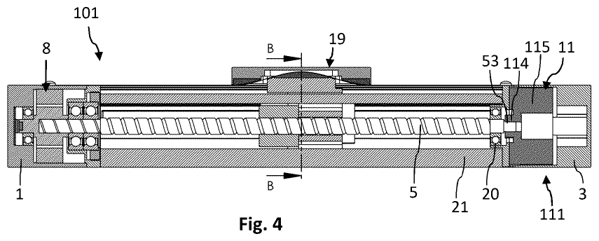

FIG. 4: A longitudinal section of another version of the linear module with a holding brake.

Identical reference signs in the figures indicate identical components.

FIG. 1A shows a side view of an embodiment of the linear module 101 according to the invention with a cuboid housing 21, a carriage 19 and an interaction element 12. The housing 21 is made of an extruded aluminum profile and has a housing cover 1, 3 on each end face at both longitudinal ends. The housing covers 1, 3 are firmly attached to the linear module 101 with screws 28. The first housing cover 1 extends in a longitudinal direction of the linear module 101 in order to be able to accommodate the motor 8 completely therein (see FIG. 3A). The second housing cover 3 is provided to support a spindle, which is arranged in a housing interior of the housing 21. In addition, the housing 21 has two body-side housing covers 23, 231 on a front surface 217, which are also fastened with screws 28. The housing covers 1, 3, 23, 231 thus enclose the housing interior of the housing 21. The interaction element 12 is arranged on one of the body-side housing covers 23. The interaction element 12 has three adjusting screws 122, 123 and three LEDs 121. Two of the adjusting screws 122 are provided for adjusting the speed of the carriage 19 separately in both longitudinal directions, IN/OUT. The other adjusting screw 123 is provided for adjusting the force. The three LEDs 121 in FIG. 1A indicate the status of the linear module 101. Furthermore, the interaction element 12 has two separate housing screws 142, which enclose connections of the control device. One of the two connections 141 is provided for the power supply and the other of the two connections 141 is provided for communication with the internal connections of the electronic control device. Through communication with the electronic control device, the control device can be configured, or a power supply of the motor, a position value of the carriage 19 relative to the spindle, a speed, an acceleration and/or a direction of movement of the carriage 19 can be individually adjusted. The carriage 19 is arranged outside the housing 21 and can be moved along the longitudinal direction of the linear module 101 by controlling the spindle by the control device.

A cross-section along the dashed line A, which runs through the two housing screws 142 of the linear module 101, is shown in FIG. 1B. The control device 14 has connections 141 on the body side, which are enclosed by the housing screws 142, so that the connections are arranged in the housing interior 211. The connections 141 are thus routed outwards through the housing cover 23 on the body side and the housing screws 142 and are connected to a rigidly mounted circuit board 13. The rigidly mounted circuit board 13 has a plurality of electronic components 22. The largest electronic components 22, in particular transistors and converters, are arranged in the outer areas of the circuit board 13 and protrude into the housing 21 on both sides of a spindle 5. Thus, the spindle 5 and a spindle nut 51 have sufficient space available in the housing interior 211 without the housing 21 having to be enlarged. In addition, the electronic components 22 are surrounded by a partition 215 extending in a circumferential direction of the spindle 5 in order to be protected from damage and contamination.

The spindle 5 is coaxially surrounded by the spindle nut 51. The spindle nut 51 is rigidly connected to a coupling unit 6, which is moveable along a guide rail 7. The guide rail 7 has a substantially rectangular cross-sectional profile, which has a recess 70 on opposite sides. A carriage 61 with a recirculating ball bearing guide, which is rigidly connected to the coupling unit 6, can engage in the recesses 70 in order to be guided. The coupling unit 6 is also connected to the carriage 19, so that a movement of the coupling unit 6 also moves the carriage 19. The coupling unit 6 is arranged below a cover 2 within an opening 212 of the housing 21. The carriage 19, on the other hand, is arranged adjacent to the cover 2 and outside the opening 212. The opening 212 extends over a large part of the linear module 101 in a longitudinal direction (see FIG. 3A). The housing 21 also has two longitudinally extending profile grooves 213 for fastening the linear module 101 on an opposite side of the housing screws 142 and on a side opposite the carriage 19 (see FIG. 1B). In addition, the housing 21 has a longitudinally extending hole 214 in each corner with a thread for attaching the screws 28, so that the covers 1, 3 can be detachably attached.

FIG. 2 shows a top view of the design of the linear module 101 according to FIG. 1A and FIG. 1B with a partial cross-section, so that the housing interior 211 of the rectangular housing 21 can be seen in the area of the control device 14. The housing 21 has an opening on an upper side surface, which is covered by a rectangular steel sheet 2 as a cover and is detachably connected to the housing 21 at four corners by a screw 30. The sheet steel 2 extends in a longitudinal direction parallel to the spindle 5 over a large part of the housing 21 including the covers 1, 3. The spindle 5 also has a thread 54 so that the spindle nut 51 (see FIG. 1B) can be guided in the longitudinal direction of the spindle 5 without rotating itself. Thus, the spindle 5 can convert the rotational movement about its rotation axis D into an axial movement of the coupling unit 6 and the carriage 19.

The carriage 19 has several connection elements on a top side 191 in the form of holes 18 with threads, so that the carriage 19 can be connected to an external device part in order to transmit force in the longitudinal direction of the linear module 101. The carriage 19 is wider than the steel sheet 2 and is connected with four screws 29 in an outer area to the coupling unit laterally past the steel sheet 2. The coupling unit and the carriage 19 are thus moveable along the steel sheet 2, driven by the spindle 5. The control device 14 in the area of the body side cover 23 can be configured by a user through the interaction elements 12 in order to adjust the control of the linear module 101, in particular the parameters for control. In addition, the control device 14 can be adapted and/or controlled by one of the connections 141. The rigidly mounted circuit board 13 with the electronic components 22 is arranged substantially parallel to the front surface 217 in the housing interior 211.

FIG. 3A shows a longitudinal section of the version of the linear module 101 according to FIG. 2 which runs vertically through the rotation axis D in FIG. 2. Together with the covers 1, 3 and the steel sheet 2, the housing 21 encloses the housing interior 211.

Only the carriage 19 is arranged completely outside the housing interior 211. The coupling unit 6 and the carriage 19 are connected to each other at the side of the steel sheet 2 (see FIG. 2) by screws. In the area of the carriage 19, the sheet steel 2 forms a curvature 24, which is contacted centrally on a bottom side by a partially convex sliding element 194 of the coupling unit 6 and is contacted on the top side by two concave sliding elements 193 of the carriage 19. The two sliding elements 193 are arranged at the edge of the carriage 19 so that they frame the central sliding element 194 of the coupling unit 6 in the longitudinal direction of the linear module 101.

One of the end covers 1 serves as a motor housing for a brushless motor 8, which is arranged coaxial to the spindle 5. The motor 8 has a stator 9, which is arranged immovably in the housing 21, and a rotor 10, which is arranged coaxially within the stator 9 and is rigidly connected to the spindle 5. The motor 8 can convert current into a rotational movement of the rotor 10 by energizing the coils of the stator 9 at the right time. The rotational movement of the rotor 10 can thus drive the spindle 5, which is rigidly connected to the rotor 10. Due to the rotational movement of the spindle 5, the spindle nut 51 with the coupling unit 6 can be guided along the guide rail 7, which runs parallel to the spindle 5 in the housing interior 211. Thus, the coupling unit 6 can be displaced in the longitudinal direction within the opening 212, so that the curvature 24 of the steel sheet 2 moves with it.

A ball bearing 17 is arranged at the end of the linear module 101 adjacent to the rotor 10. On the opposite side of the rotor 10, two ball bearings 171 are arranged next to each other to support the spindle 5. The opposite end cover 3 also has a ball bearing 20.

A magnet 15 is arranged in the end cover 1 behind the spindle 5 with the rotation axis D. The magnet 15 is rigidly connected to a connection element 55, which is rigidly connected to the spindle 5. The rotor 10 is also arranged on the connection element 55. The polarity of the magnet 15 extends in the direction radially outwards of the linear module 101. An encoder device 16 for reading out an angular position of the spindle and/or the axial position of the carriage 19 is arranged in the axial direction behind the magnet 15. A circuit board 161 of the encoder device 16 is also connected to the control device of the linear module 101, so that the control, in particular the motor control of the brushless motor 8, can be adapted with respect to the angular position and/or position of the coupling unit 6.

FIG. 3B shows a cross-section of the linear module 101 perpendicular to the straight line C in FIG. 3A. The housing 21 has longitudinal profile grooves 213 on two side surfaces. There are also holes 214 in the corners of the housing 21 for connecting the covers. The carriage 19 in FIG. 3B is arranged outside the housing 21 and the coupling unit 6 is arranged inside the longitudinally extending opening 212. The carriage 19 and the coupling unit 6 together enclose an area of the steel sheet 2 with the curvature 24 (see FIG. 3A). The coupling unit 6 is also rigidly connected to the carriage 61 with the recirculating ball bearing guide, so that the coupling unit 6 can be guided along the guide rail 7 in opposing recesses 70 of the guide rail 7. The spindle nut, which engages in the thread of the spindle 5 in order to move the coupling unit 6 in the axial direction, is separated by a partition 215 of the housing 21 from an area 216 for receiving the control device of the housing interior 211.

FIG. 4 shows a further embodiment of a linear module 101 with an electrical holding brake 11 in an end cover 3 opposite an end cover 1 for mounting a brushless motor 8 for driving a spindle 5.

Apart from the holding brake 11 in the front cover 3, the embodiment of the linear module 101 in FIG. 4 is identical to the linear module 101 described above in FIG. 1A to FIG. 3B, so there is no need to describe it again.

The cover 3, which serves as a holding brake housing for the holding brake 11, also has a ball bearing 20 for mounting a spindle 5. In FIG. 4, the holding brake 11 is in a holding state 111 so that rotational movement of the spindle 5 is prevented.

The holding brake 11 has a braking element 115. In addition, the holding brake 11 has a disk-shaped hub 114. The hub 114 is rotatably supported relative to the brake element 115 (not explicitly shown in FIG. 4). The hub 114 is form-fittingly coupled to a radial recess 53 at one end of the spindle 5. The hub 114 is arranged coaxially around the end of the spindle 5. The hub 114 of the holding brake 11 and the end of the spindle thus engage in a form-fitting manner both in a release state and in the holding state 111.

In the release state (not shown in FIG. 4) of the holding brake 11, in which the holding brake 11 is energized, the spindle 5 is thus rotatable together with the hub 114.

By energizing the holding brake 11, the hub 114 is electromagnetically released against a preload of a reset element (not shown in FIG. 4) to allow the spindle 5 to rotate.

In the release state of the holding brake 11, the carriage 19 can thus be moved by a rotational movement of the spindle 5.

In the holding state 111 of the holding brake 11, in which the holding brake 11 is not or only insufficiently energized, the spindle 5 together with the hub 114 cannot be rotated. The holding state 111 of the holding brake 11 is automatically assumed by the holding brake 11 in a de-energized state due to the pretension of the resetting element.

Due to the pretension of the resetting element, the spindle 5 and the hub 114 are prevented from rotating in the holding state 111 by a frictional connection. For this purpose, the hub 114 can be pressed against a component of the holding brake 11 or the housing 21 by the resetting element. Alternatively, a separate component of the holding brake 11, in particular the brake element 115, can be pressed against the hub 114.

1-17. (canceled)

18. A linear module comprising
a spindle for rotating about a rotation axis of the spindle,
a spindle nut for converting a rotational movement of the spindle into an axial movement of the spindle nut,
a coupling unit for axial movement along a guide rail, driven via the spindle nut,
the guide rail for guiding the coupling unit, which runs parallel to the spindle,
a motor with a stator, and a stator for driving the spindle, motor with a stator and a rotor for driving the spindle,
a control device which is configured for controlling the motor and comprises at least one circuit board,
a housing which at least partially encloses a housing interior, and
a carriage which is arranged at least partially outside the housing and is coupled to a movement of the coupling unit, so that the carriage is moveable parallel to the guide rail by the movement of the coupling unit,
wherein the motor, the control device, the spindle, spindle nut and the guide rail are arranged in the housing interior.

19. The linear module according to claim 18, wherein the linear module comprises a cover and the housing has an opening which is at least partially covered with the cover and
the carriage is arranged at least partially outside the housing, adjacent to a top side of the cover, and is connected to the coupling unit, which is arranged adjacent to a bottom side of the cover.

20. The linear module according to claim 18, wherein the motor is arranged coaxially to the spindle, so that the rotor and the spindle have the same rotation axis.

21. The linear module according to claim 18, wherein the coupling unit comprises a ball or roller recirculation, which has a plurality of rollers or balls that allow the coupling unit to run with low friction relative to the guide rail.

22. The linear module according to claim 18, wherein the linear module comprises a holding brake and a holding state of the holding brake can be reversibly converted into a release state of the holding brake,
wherein the holding state prevents a rotational movement of the spindle and
the release state enables rotational movement of the spindle.

23. The linear module according to claim 22, wherein the holding brake is an electrical holding brake and has a mechanical transmission element, wherein the electrical holding brake is designed such that the holding state can be achieved in a de-energized state of the holding brake.

23. The linear module according to claim 22, wherein the holding brake is arranged at one end of the spindle and the end of the spindle has at least one of at least one radial projection and at least one radial recess, wherein at least one of the at least one projection and the at least one recess is at least partially form-fittingly coupled to a hub of the holding brake in the holding state.

25. The linear module according to claim 18, wherein the control device is configured to control at least two of the following parameters:
a power supply for controlling the motor for commutation of the motor,
a position value defined by the relative distance of the carriage to one end of the spindle,
a speed of the movement of the coupling unit,
acceleration of the movement of the coupling unit,
a force of the movement of the coupling unit,
direction of movement of the coupling unit.

26. The linear module according to claim 18, wherein the circuit board comprises small and large electronic components with respect to the overall height perpendicular to the circuit board plane, wherein at least one of transistors and converters, are arranged at the edge of the circuit board of a longer side of the circuit board.

27. The linear module according to claim 18, wherein the control device comprises a connection for power supply and a connection for communication with the control device.

28. The linear module according to claim 18, wherein the linear module comprises an interaction element, wherein the interaction element comprises at least one of adjustment elements and status indicators, wherein the adjustment elements are used for at least one of speed adjustment and force adjustment directly on the linear module.

29. The linear module according to claim 18, wherein at least one connection element is present, wherein at least one connection element is arranged on the carriage and at least one further connection element is formed at one end or at both ends of the housing.

30. The linear module according to claim 18, wherein a minimum cross-sectional dimension of the linear module orthogonal to the spindle axis is never wider than 150% of an outer diameter of the motor, apart from the connections protruding from the housing, the interaction elements, housing screws and the carriage.

31. The linear module according to claim 18, wherein the housing comprises two housing covers on the end face, wherein one of the end-side housing covers is at the same time a motor housing of the motor.

32. A linear module, comprising
a brushless motor with stator and rotor, a spindle, a spindle nut for converting a rotational movement of the spindle into an axial movement of a coupling unit, the coupling unit for moving axially along a guide rail driven by the rotation of the spindle,
a guide rail for guiding the coupling unit, which extends parallel to the spindle, and
a carriage, which is coupled to the coupling unit, so that the carriage is moveable parallel to the spindle by a movement of the coupling unit, and
at least one magnet on or in an end face of the rotor and/or the spindle as well as an electronic encoder device substantially arranged axially to a rotation axis of the spindle for reading out the angular position of the magnet and/or determining the axial position of the carriage.

33. The linear module according to claim 32, wherein the magnet has the north pole on one side radially remote from the rotation axis.

34. The linear module according to claim 32, wherein the magnet with encoder device serves to determine at least one of the rotational speed of the rotor, the rotational speed of the spindle, and a commutation of the brushless motor by means of the signal of at least one of the electronic encoder device and/or a control device.

35. The linear module according to claim 19, wherein the carriage is arranged completely outside the housing.

36. The linear module according to claim 19, wherein the cover is a flexible cover.

37. The linear module according to claim 20, wherein the rotor is rigidly connected to the spindle.

38. The module according to claim 31, wherein the other of the end-side housing covers is one of a support for the spindle and a holding brake housing of the holding brake.
